(19) United States
(12) Patent Application Publication
(10) Pub. No.: US 2016/0050040 A1
(43) Pub. Date: Feb. 18, 2016

(54) RADIO COMMUNICATION SYSTEM AND RADIO COMMUNICATION METHOD

(71) Applicant: MITSUBISHI ELECTRIC CORPORATION, Tokyo (JP)

(72) Inventors: Tetsuya KOSAKA, Tokyo (JP); Nobuo KIKUCHI, Tokyo (JP); Ryoji ONO, Tokyo (JP)

(73) Assignee: Mitsubishi Electric Corporation, Tokyo (JP)

(21) Appl. No.: 14/784,186

(22) PCT Filed: May 9, 2013
(86) PCT No.: PCT/JP2013/002985

§ 371 Date: Oct. 13, 2015

(51) Int. Cl. H04J 11/00; H04W 4/08; H04W 28/12; H04W 74/06; H04W 28/02

(52) U.S. Cl. CPC H04J 11/005; H04W 74/06; H04W 28/0289; H04W 28/12; H04W 4/08

(57) ABSTRACT

A radio communication system according to the present invention includes a plurality of nodes that collect data of apparatuses and an access point that collects the data of the plurality of nodes. The access point arranges the plurality of nodes into a plurality of groups including nodes, each of which can receive radio waves transmitted from one another, the number of the nodes being equal to or smaller than a number with which interference avoidance of radio by an access method for avoiding congestion efficiently functions. The access point transmits a polling packet for granting a transmission right to each of the groups. When determining that a transmission right is granted to the group to which the plurality of nodes belong, the plurality of nodes transmit the data to the access point while avoiding interference with the other nodes in the group according to the access method.

### FIELD

The present invention relates to a radio communication system and a radio communication method for collecting information from sensors set in a plurality of places.

### BACKGROUND

A conventional radio communication system includes an access point and a plurality of terminals. The access point creates a plurality of groups to group terminals capable of performing transmission and reception one another and prevent hidden terminals from being present in the respective groups. For example, the access point groups the terminals into a group A and a group B. The access point allocates a communication section and a standby section to each of the groups and performs communication with the terminals in each of the groups.

As a method of switching communication with the group A and the group B, RTS/CTS packets are used. To request transmission permission for the group A, any one of the terminals belonging to the group A transmits the RTS packet to the access point. The access point returns the CTS packet as the transmission permission for the group A. The terminal belonging to the group A determines from the received CTS packet that the terminal is in the communication section of the group A. When determining that the terminal is in the communication section, the terminal performs, according to a CSMA/CA system, data communication with the access point until the communication section ends.

### CITATION LIST

### Patent Literature

Patent Literature 1: WO2005/067213 (e.g., paragraphs 0020, 0023, 0024, 0033, and 0034 and FIG. 4).

### SUMMARY

### Technical Problem

In the conventional radio communication system, terminals that cannot receive radio waves transmitted to each other sometimes simultaneously perform transmission and reception to cause interference. Such a program is called a hidden terminal problem. In Patent Literature 1, grouping is performed for the purpose of separating hidden terminals into different groups. Therefore, the numbers of terminals in groups are likely to be different. That is, in Patent Literature 1, there is a problem in that overall communication efficiency is deteriorated because of the sparse or dense of the number of terminals in the group.

The present invention has been devised in view of the above and it is an object of the present invention to enable an access point to efficiently perform information collection from terminals (in the following explanation, referred to as nodes).

### Solution to Problem

In order to solve the aforementioned problems, a radio communication system according to the present invention is constructed to include: a plurality of nodes that collect data of apparatuses; and an access point that collects the data contained in the plurality of nodes, wherein the access point arranges, on the basis of neighborhood-node received power information, which is received power information of a radio wave transmitted by neighborhood nodes in each of the nodes, the plurality of nodes into a plurality of groups each including nodes, each of which can mutually receive radio waves transmitted from one another, a number of the nodes being equal to or smaller than a number with which interference avoidance of radio by an access method for avoiding congestion efficiently functions, notifies the plurality of nodes of information related to a group to which each of the nodes belongs, and transmits a polling packet for granting a transmission right to each of the groups, and when, from the received polling packet, determining that a transmission right is granted to a group to which each of the plurality of nodes belongs, each of the nodes transmits the data to the access point as a packet while avoiding interference with the other nodes in the same group according to the access method.

### Advantageous Effects of Invention

According to the present invention, with the configuration explained above, it is possible to efficiently perform information collection from the nodes.

### BRIEF DESCRIPTION OF DRAWINGS

FIG. 1 is a diagram showing the configuration of a radio communication system according to a first embodiment.

FIG. 2 is a diagram showing the hardware configuration of an AP according to the first embodiment.

FIG. 3 is a diagram showing the hardware configuration of a node according to the first embodiment.

FIG. 4 is a diagram showing a communication phase for constructing a node group according to the first embodiment.

FIG. 5 is a diagram showing a state before generation of a node group according to the first embodiment.

FIG. 6 is a diagram showing a node group provisionally generated according to node group generation conditions according to the first embodiment.

FIG. 7 is a diagram showing the configuration of a radio communication system according to the first embodiment.

FIG. 8 is a diagram showing a field configuration f a group polling packet according to the first embodiment.

FIG. 9 is a diagram showing a normal communication sequence of information collection from nodes by the group polling packet according to the first embodiment.

FIG. 10 is a diagram showing a communication sequence in the case of failure in communication between an AP and nodes according to a second embodiment.

FIG. 11 is a diagram showing a communication sequence in the case of failure in communication between an AP and nodes and absence of a band for causing the node failed in the communication to perform transmission a plurality of times.

### DESCRIPTION OF EMBODIMENTS

### First Embodiment

A radio communication system according to a first embodiment is explained in detail below with reference to the drawings. The present invention is not limited by the first embodiment.

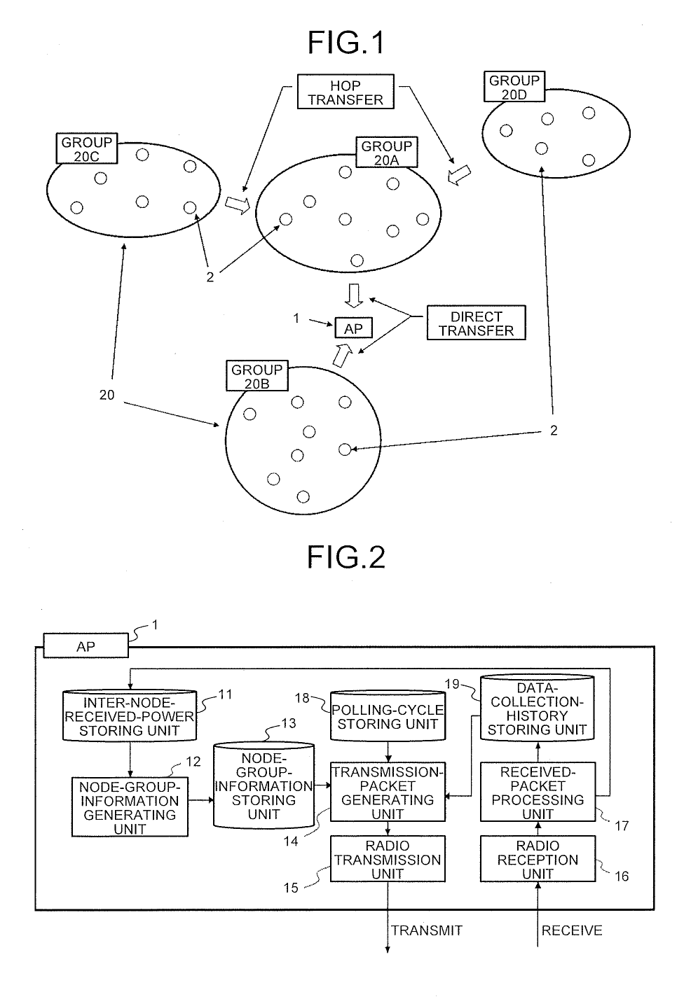

FIG. 1 is a diagram showing the configuration of a radio communication system according to a first embodiment of the present invention. As shown in FIG. 1, the radio communication system according to the first embodiment is configured by one access point (in the following explanation, referred to as AP 1) and a plurality of nodes 2. In the first embodiment, the plurality of nodes 2 are configured from any arbitrary number of nodes 2. The nodes 2 respectively have sensor information. For example, when the node 2 is a power meter, the sensor information is power consumption measured in an apparatus in which the node 2 is set. For example, when the node 2 is a thermometer, the sensor information is temperature measured in the apparatus in which the node 2 is set. For example, when the node 2 is a flow meter, the sensor information is a flow rate measure in the apparatus in which the node 2 is set. The AP 1 collects the sensor information of the nodes 2. The nodes 2 form a mesh network including a mesh configuration (a mesh-like network configuration in which the nodes 2 perform communication with one another). Note that a sensor of the present invention is equivalent to the node 2. An information collecting apparatus of the present invention is equivalent to the AP 1.

As shown in FIG. 1, the nodes 2 are divided into groups configured by a plurality of nodes 2 (in the following explanation, referred to as node groups 20). Note that, in the first embodiment, the node groups 20 refer to node groups 20A, 20B, 20C, and 20D. In the radio communication system according to the first embodiment, node group generation conditions for dividing the nodes 2 into the node groups 20A, 20B, 20C, and 20D are explained below.

In the first embodiment, “destination” designation for a packet explained below indicates a “destination” in a protocol (e.g., the Internet Protocol) in a network layer in use. The network layer represents a third layer among seven layers in an OSI reference model. Further, in the first embodiment, the nodes 2 configuring the node group 20A and the nodes 2 configuring the node group 20B shown in FIG. 1 directly perform transmission and reception of packets with the AP 1. The nodes 2 configuring the node group 20C and the nodes 2 configuring the node group 20D perform transmission and reception of packets with the AP 1 through multi-hop transfer. In the first embodiment, a packet to be multi-hop transferred is multi-hop transferred by the nodes 2 on the basis of a routing path of the radio communication system explained below.

A principle according to the first embodiment is explained. In a factory, a plant, or the like, a large number of nodes 2 are set in a wide range, for example, around machine tools set in the factory. The nodes 2 cyclically collect information such as operation states of the machine tools. For example, when a large number of machine tools are set in the factory, the nodes 2 are increased according to the number of machine tools. Therefore, the radio communication system becomes a large-scale network. As an example, in the following explanation, the operation of load facilities such as machine tools is controlled so as to prevent maximum demanded power (in the following explanation, referred to as demand) in the factory from exceeding a contract power value with a power company. In this example, the nodes of the formed network collect information concerning power consumption of the load facilities such as the machine tools.

In the example explained above, the AP 1 collects, from the nodes 2, the information concerning the power consumption of the load facilities such as the machine tools using narrowband radio such as specified low power radio. Note that the nodes 2 form, for example, a mesh network.

As a method of controlling communication between the nodes 2 and the AP 1, there is a polling communication control method. In the polling communication control method, the AP 1 transmits, to the nodes 2 with which the AP 1 can directly communicate, a data transmission request packet (in the following explanation, referred to as polling packet) for each of the nodes 2. The nodes 2 receiving the polling packet from the AP 1 transmit collected sensor information such as power consumption of apparatuses to the AP 1 according to the polling packet. When a large number of nodes 2 are set in a large factory or the like, the polling communication control method is used to avoid conflict (congestion) of communication from the large number of nodes 2 to the AP 1.

However, when the AP 1 collects information from the large number of nodes 2, in the polling communication control system, in order to collect the information concerning the power consumption of the load facilities such as the machine tools from the nodes 2, the AP 1 needs to transmit a large quantity of polling packets to the large number of nodes 2. When the AP 1 collects the information concerning the power consumption of the load facilities such as the machine tools from the nodes 2 using the narrowband radio such as the specified low power radio, a band of the narrowband radio is oppressed by not only the influence due to the conflict of the communication from the nodes 2 but also the large quantity of polling packets.

On the other hand, in the radio communication system of Patent Literature 1, the nodes 2 are grouped to be one and the AP 1 transmits one CTS packet (the CTS packet is equivalent to the polling packet) to the nodes 2. The polling packet grants a transmission right to only the nodes 2 belonging to a specific group. With such a configuration, as a result, it is possible to reduce the number of polling packets transmitted by the AP 1, and it is possible to suppress the oppression of the band by the polling packet.

However, when nodes that can receive radio waves transmitted by the nodes from the other nodes are divided into the node groups 20 only under a condition that the nodes are grouped, the numbers of nodes 2 configuring the node groups 20 are likely to be different among the node groups 20. That is, overall communication efficiency is deteriorated by the sparse or dense of the number of nodes of each of the node groups 20.

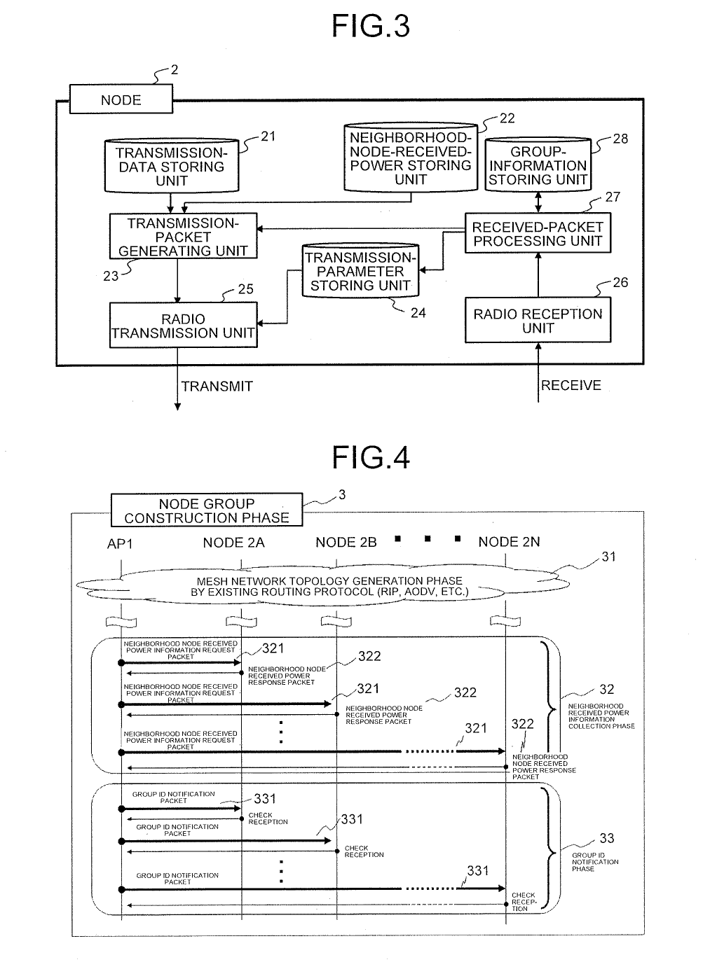

The hardware configurations of the AP 1 and the node 2 according to the first embodiment are explained. Hardware configurations and operations related to construction of the node group 20 are explained with reference to FIG. 2, FIG. 3, and FIG. 4.

FIG. 2 and FIG. 4 are diagrams showing the hardware configuration and the operation of the AP 1 according to the first embodiment of the present invention. In FIG. 2, an inter-node-received-power storing unit 11 stores neighborhood-node received power information collected from each of the nodes 2. The neighborhood-node received power information is information of received power (hereinafter may be referred to just as “received power information”) in the nodes 2 of a radio wave transmitted by the other nodes 2 in the neighborhood.

In FIG. 2, a node-group-information generating unit 12 divides, on the basis of the neighborhood-node received power information stored in the inter-node-received-power storing unit 11, the nodes into the node groups 20A, 20B, 20C, and 20D according to a first node group generation condition, and a second node group generation condition and generates the node groups 20. The node group generation conditions are explained in detail below. The node-group-information generating unit 12 selects a group polling packet broadcast node concerning the node groups 20A, 20B, 20C, and 20D.

In FIG. 2, a node-group-information storing unit 13 stores node group information concerning the node groups 20A, 20B, 20C, and 20D generated by the node-group-information generating unit 12. The node group information is explained below.

In FIG. 2, a transmission-packet generating unit 14 generates a neighborhood-node received power information request packet 321. The neighborhood-node received power information request packet 321 is a packet with which the AP 1 requests the nodes 2 to transmit neighborhood-node received power information.

The transmission-packet generating unit 14 generates a group ID notification packet 331 shown in FIG. 4. The group ID notification packet 331 is a packet for notifying the nodes 2 of belonging group information. The belonging group information means a “group ID” and “a reference position of a transmission method control bitmap field 42” explained below. The group ID means an identifier for identifying the node group 20.

In FIG. 2, a radio transmission unit 15 transmits the neighborhood-node received power information request packet 321 or the group ID notification packet 331 generated by the transmission-packet generating unit 14.

In FIG. 2, a radio reception unit 16 sends a received packet to a received-packet processing unit 17. When receiving a neighborhood-node received power information response packet 322 shown in FIG. 4 from a node 2, the received-packet processing unit 17 stores the information in the inter-node-received-power storing unit 11.

FIG. 3 and FIG. 4 are diagrams showing the hardware configuration and the operation of the node 2 according to the first embodiment of the present invention. In FIG. 3, a transmission-data storing unit 21 stores, as transmission data, data to be transmitted to the AP 1.

In FIG. 3, neighborhood-node received-power-information storing unit 22 stores information concerning received power of radio waves transmitted by the other nodes 2 in the neighborhood, that is, neighborhood-node received power information.

In FIG. 3, a transmission-packet generating unit 23 generates a neighborhood-node received power information response packet 322 shown in FIG. 4 on the basis of information of the neighborhood-node received-power-information storing unit 22.

In FIG. 3, a communication-parameter storing unit 24 stores communication parameters explained below. A radio transmission unit 25 transmits the neighborhood-node received power information response packet 322 generated by the transmission-packet generating unit 23. When transmitting a packet, the radio transmission unit 25 performs transmission control (CSMA/CA control, etc.) of the packet on the basis of the communication parameters of the communication-parameter storing unit 24.

In FIG. 3, a radio reception unit 26 sends a received packet to a received-packet processing unit 27. When receiving the neighborhood-node received power information request packet 321 shown in FIG. 4 from the AP 1, the received-packet processing unit 27 notifies the transmission-packet generating unit 23 of a neighborhood-node received power request. When receiving the group ID notification packet 331 shown in FIG. 4 from the AP 1, the received-packet processing unit 27 stores the notified belonging group information in a group-information storing unit 28.

In FIG. 3, a group-information storing unit 28 stores the belonging group information notified from the received-packet processing unit 27.

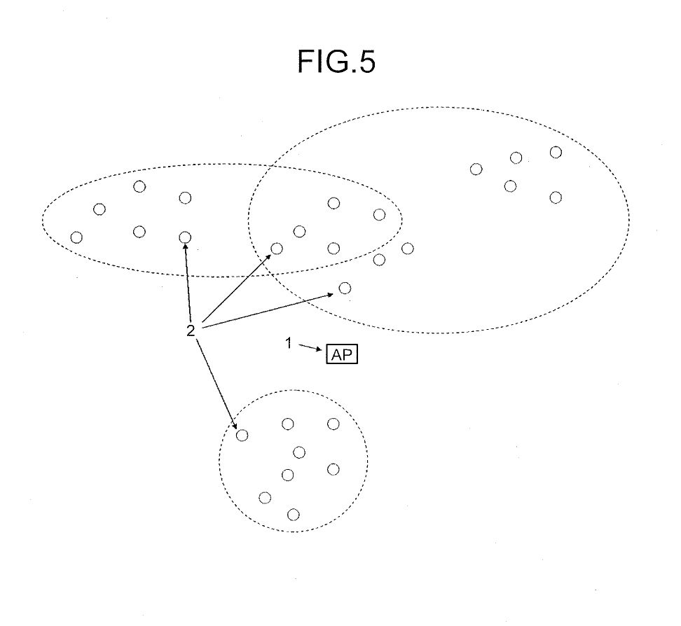

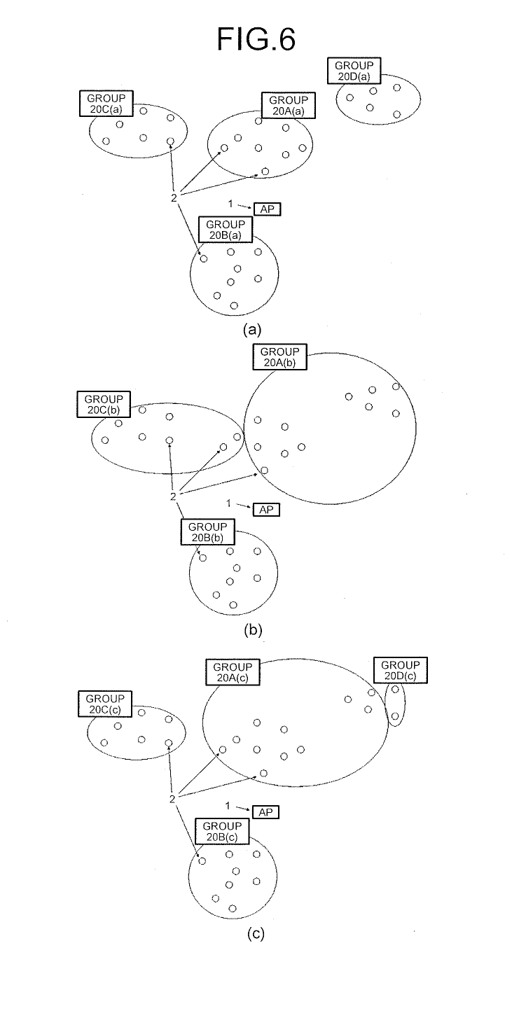

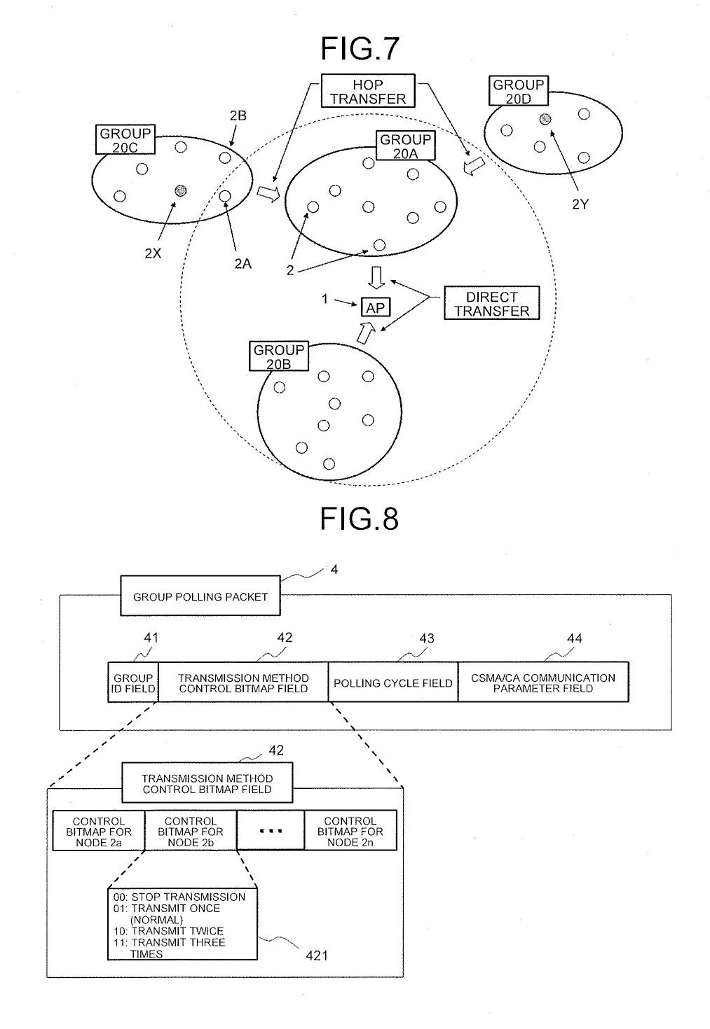

A procedure for constructing the node group 20 is explained with reference to FIG. 3, FIG. 4, FIG. 5, FIG. 6, and FIG. 7. FIG. 4 is a diagram showing a node group construction phase 3 for constructing the node group 20 according to the first embodiment. As shown in FIG. 4, the node group construction phase 3 is configured from a network topology generation phase 31, a neighborhood received power information collection phase 32, and a group ID notification phase 33.

In FIG. 4, the network topology generation phase 31 is a phase for generating a network topology of the AP 1 and all the nodes 2 according to an existing routing protocol. In the network topology generation phase 31, all the nodes 2 perform transmission and reception of packets one another. When the packets are transmitted and received, the routing protocol uses a method such as RIP or AODV as a protocol for an existing radio communication system. In this way, a routing path of a network is constructed and a network topology is generated.

At this point, as shown in FIG. 3, the nodes 2 store, in the neighborhood-node received-power-information storing unit 22, node IDs and received power related to all the received packets. The node IDs means identifiers for identifying the nodes 2. The node IDs are given to the packets when the nodes 2 transmit the packets. In FIG. 4, the nodes 2 acquire, from the node IDs and the received power related to the received packets, neighborhood-node received power information related to the nodes 2 that transmit the packets. That is, in the network topology generation phase 31, the nodes 2 collect the neighborhood-node received power information and store the neighborhood-node received power information in the neighborhood-node received-power-information storing unit 22.

As shown in FIG. 4, in the neighborhood-node received power information collection phase 32, the AP 1 transmits the neighborhood-node received power information request packets 321 to all the nodes 2. In response, the nodes 2 transmit the neighborhood-node received power information response packet 322 to the AP 1. The AP 1 receives the neighborhood-node received power information response packet 322 from the nodes 2 to thereby collect the neighborhood-node received power information of all the nodes 2.

In FIG. 4, in the group ID notification phase 33, the node-group-information generating unit 12 of the AP 1 generates the node groups 20A, 20B, 20C, and 20D. The node-group-information generating unit 12 generates, on the basis of the collected neighborhood-node received power information, the node groups 20A, 20B, 20C, and 20D in accordance with the node group generation conditions.

The node group generation conditions are specifically explained with reference to FIG. 5 and FIG. 6. FIG. 5 is a diagram showing a state before the node groups 20 are generated. In the state shown in FIG. 5, the nodes 2 are not divided into the node groups 20 yet. The node-group-information generating unit 12 determines, on the basis of the neighborhood-node received power information, whether each of the nodes 2 can receive radio waves transmitted from the other nodes. In FIG. 5, dotted lines indicate ranges in each of which each of the nodes 2 can receive the radio waves transmitted from the other nodes. That is, each of the nodes 2 can directly perform communication with the other nodes 2 located within the same dotted lines shown in FIG. 5.

As a first step, the AP 1 provisionally generates the node groups 20 from a result of the determination. FIG. 6 is a diagram showing the provisional node groups 20 generated in the first step. The AP 1 divides the nodes 2 into the node groups 20, for example, according to dividing methods shown in FIG. 6-(a), FIG. 6-(b), and FIG. 6-(c). As shown in FIG. 5 and FIG. 6, in all of the dividing methods shown in FIG. 6-(a), FIG. 6-(b), and FIG. 6-(c), the nodes 2 in the node groups 20 can receive radio waves transmitted from the other nodes.

As a second step, the AP 1 finally determines the node groups 20 by further limiting, concerning the provisionally generated node groups 20, the number of nodes to be equal to or smaller than a number with which Listen Before Talk (in the following explanation, referred to as CSMA/CA) efficiently operates. In FIG. 6-(a), the nodes 2 in node groups 20A(a), 20B(a), 20C(a), and 20D(a) can efficiently perform, by performing CSMA/CA communication, avoidance of congestion with the other nodes 2 in the node group 20 to which the nodes 2 belong.

In FIG. 6-(b), a node group 20A(b) includes a large number of nodes 2 belonging to the node group 20A(b). Therefore, the nodes 2 in the node group 20A(b) cannot efficiently perform the CSMA/CA communication. The nodes 2 in node groups 20B(b) and 20C(b) can efficiently perform, by performing the CSMA/CA communication, avoidance of congestion with the other nodes 2 in the node groups 20B(b) and 20C(b) to which the nodes 2 belong.

In FIG. 6-(c), a node group 20A(c) includes a large number of nodes 2 belonging to the node group 20A(c). Therefore, the nodes 2 in the node group 20A(c) cannot efficiently perform the CSMA/CA communication. The nodes 2 in node groups 20B(c), 20C(c), and 20D(c) can efficiently perform, by performing the CSMA/CA communication, avoidance of congestion with the other nodes 2 in the node groups 20B(c), 20C(c), and 20D(c) to which the nodes 2 belong.

Therefore, the AP 1 selects the dividing method shown in FIG. 6-(a) among the dividing methods for the provisionally generated node groups 20.

In this way, the node-group-information generating unit 12 generates the node groups 20A, 20B, 20C, and 20D in which the CSMA/CA communication shown in FIG. 1 can be efficiently performed for all the nodes 2.

As explained above, in the first embodiment, the node group generation conditions are as follows. In the first node group generation condition, the AP 1 generates the node groups 20 including the nodes 2, each of which can directly receive radio waves transmitted from the other nodes. In the second node group generation condition, in the node groups 20, the AP 1 limits the number of nodes 2 to be equal to or smaller than a number with which interference avoidance of radio by the CSMA/CA, which is an access method for avoiding congestion, efficiently operates. The AP 1 generates, according to the first node group generation condition and the second node group generation condition, the node groups 20A, 20B, 20C, and 20D including the limited number of nodes. That is, the AP 1 divides the nodes 2 into the node groups 20A, 20B, 20C, and 20D according to the first node group generation condition and the second node group generation condition.

Note that, in the second step, even when a large number of nodes 2 belong to the node group 20, if each of the nodes 2 in the node group 20 can receive radio waves transmitted from the other nodes, congestion can be avoided by the CSMA/CA communication. However, when there are a large number of nodes 2 in the node group 20, the nodes 2 in the node group 20 cannot efficiently perform the CSMA/CA communication. In this case, the nodes 2 in the node group 20 consumes time to avoid congestion of communication. Therefore, the AP 1 cannot efficiently perform information collection from the nodes 2 in the radio communication system. Therefore, in the second step, the AP 1 limits the number of nodes 2 in the node groups 20 to be equal to or smaller than a number with which avoidance congestion by the CSMA/CA can be efficiently performed.

After the generation of the node groups 20A, 20B, 20C, and 20D, the AP 1 transmits a group polling packet 4 for granting a transmission right to each of the node groups 20A, 20B, 20C, and 20D. The nodes 2 perform communication with the AP 1 according to the received group polling packet 4. Note that the group polling packet is as shown in FIG. 8.

The group polling packet 4 is a polling packet that the AP 1 transmits to grant transmission rights to the node groups 20A, 20B, 20C, and 20D. The group polling packet 4 has a group ID related to a specific node group 20 to which the transmission right is granted.

In FIG. 7, after the node groups 20A, 20B, 20C, and 20D are generated in accordance with the node group generation conditions, the node-group-information generating unit 12 selects a group polling packet broadcast node for each of the node groups 20.

The group polling packet broadcast node means the node 2 that broadcasts the group polling packet 4 received from the AP 1 to the other nodes 2 in the node group 20. The node-group-information generating unit 12 selects, as the group polling packet broadcast node, the node 2 having a highest minimum value of neighborhood-node received power in the node groups 20A, 20B, 20C, and 20D or the AP 1. That is, the node-group-information generating unit 12 selects, as the group polling packet broadcast node, the node 2 having an optimum communication state with the neighboring nodes 2 among the nodes 2 in the node groups 20A, 20B, 20C, and 20D or the AP 1.

The selection of the group polling packet broadcast node is explained more in detail below. FIG. 7 is a diagram for explaining the configuration of the radio communication system shown in FIG. 1 more in detail. In FIG. 7, a dotted line indicates a range of the nodes 2 with which the AP 1 can directly communicate. That is, the AP 1 can directly perform communication with the nodes 2 located within the dotted line shown in FIG. 7.

In FIG. 7, there are three types of the generated node groups 20. The three types are (1) the node groups 20A and 20B including only the nodes 2 that can directly communicate with the AP 1, (2) the node group 20C including a node 2A that can directly communicate with the AP 1 and nodes 2B that cannot directly communicate with the AP 1, and (3) the node group 20D including only the nodes 2 that cannot directly communicate with the AP 1.

In FIG. 7, the node group 20A and the node group 20B are the node groups 20 including only the nodes 2 with which the AP 1 can directly communicate. Therefore, in the first embodiment, the AP 1 itself is the group polling packet broadcast node of the node group 20A and the node group 20B.

In FIG. 7, the node group 20C is (2) the node group 20 including the node 2A with which the AP 1 can directly communicate and the nodes 2B with which the AP 1 cannot directly communicate. The node group 20D is (3) the node group 20 including only the nodes 2 that cannot directly communicate with the AP 1. Therefore, in the node group 20C and the node group 20D, the node-group-information generating unit 12 selects the group polling packet broadcast node out of the nodes 2 belonging to the node groups 20. In the first embodiment, a node 2X shown in FIG. 7 is the node 2 having a highest minimum value of neighborhood-node received power among the nodes 2 belonging to the node group 20C. A node 2Y shown in FIG. 7 is the node 2 having a highest minimum value of neighborhood-node received power among the nodes 2 belonging to the node group 20D. Therefore, the node-group-information generating unit 12 selects the nodes 2X and 2Y shown in FIG. 7 as the group polling packet broadcast nodes of the node group 20C and the node group 20D.

In FIG. 3 and FIG. 4, after the selection of the group polling packet broadcast nodes, the AP 1 notifies, using the group ID notification packet 331, the nodes 2 of group IDs related to the node groups 20 to which the nodes 2 belong. When receiving the group ID notification packet 331, the nodes 2 store, in the group-information storing unit 28, the group IDs of the node groups 20 to which the nodes 2 belong.

According to the procedure explained above, the radio communication system according to the first embodiment constructs the node groups 20 related to the radio communication system. The node group construction phase 3 is executed when the nodes 2 are added or deleted in addition to the initialization time of the radio communication system.

The group polling packet 4 transmitted by the AP 1 is explained with reference to FIG. 8. In the radio communication system according to the first embodiment, the nodes 2 perform communication according to the group polling packet 4 transmitted by the AP 1. FIG. 8 is a diagram showing a field configuration of the group polling packet 4 generated by the transmission-packet generating unit 14 of the AP 1.

In FIG. 8, a group ID field 41 is a field indicating the node group 20 that is a polling target. When receiving the group polling packet 4 from the AP 1, the node 2 determines whether a group ID indicated in the group ID field 41 coincides with a group ID of the node group 20 to which the node 2 belongs. When the group IDs coincide with each other, the node 2 determines that the received group polling packet 4 is the group polling packet 4 addressed to the node group 20 to which the node 2 belongs. Consequently, the node 2 determines that a transmission right is granted to the node group 20 to which the node 2 belongs.

In FIG. 8, a transmission method control bitmap field 42 is a field for controlling a transmission method of the nodes 2 belonging to a relevant node group 20. The transmission method control bitmap field 42 is configured from a control bitmap 421 for each of the nodes 2 configuring the relevant node group 20. The control bitmap 421 indicates transmission method of the relevant node 2. Each of the nodes 2 transmits data according to the transmission method indicated by the control bitmap 421 related to the node 2 itself. Note that the control bitmap 421 is referred to as a reference position of the transmission method bitmap field 42 of the relevant node 2.

In the transmission method in the first embodiment, the number of transmissions from the node 2 to the AP 1 is one. Note that, in the explanation of the first embodiment, a modulation method and a demodulation method are not specified and can be any modulation method and any demodulation method.

In FIG. 8, a polling cycle field 43 is a field indicating an information collection cycle (in the following explanation, referred to as “polling cycle”) of the relevant node group 20. The polling cycle means a cycle at which the AP 1 transmits the group polling packet 4 and is decided for each of the node groups 20A, 20B, 20C, and 20D. That is, in the polling cycle field 43, a polling cycle related to the node group 20 to which a transmission right is granted is indicated. The polling cycle indicated in the polling cycle field 43 is the same as a polling cycle of the relevant node group 20 stored in a polling-cycle storing unit 18 of the AP 1 explained below.

In FIG. 8, a CSMA/CA communication parameter field 44 is a field indicating communication parameters of the CSMA/CA used by the nodes 2 in the relevant node group 20. The AP 1 sets the CSMA/CA communication parameters to optimum parameters taking into account the number of nodes of the node group 20, a radio bandwidth in use, and the like. The CSMA/CA communication parameter field 44 is a field transmitted when, for example, the number of nodes 2 changes, for example, the nodes 2 configuring the node groups 20 are added or deleted.

The configuration of hardware used by the AP 1 in collecting information from the nodes 2 is explained with reference to FIG. 2, FIG. 3, FIG. 7, and FIG. 8. Note that the units in the AP 1 and the nodes 2 include components and functions related to the construction of the node groups 20 in addition to components and functions explained below.

In FIG. 2 and FIG. 8, the node-group-information generating unit 12 generates a group ID, the control bitmap 421 for each of the nodes 2 in the transmission method control bitmap field 42, and optimum CSMA/CA communication parameters corresponding to the number of nodes of the node groups 20.

In FIG. 2 and FIG. 8, the node-group-information storing unit 13 stores information concerning: (1) the group ID, (2) the constituent nodes 2 of the node groups 20, (3) the control bitmap 421 for each of the nodes 2, (3) the CSMA/CA communication parameters of each of the node groups 20, and (4) the group polling packet broadcast nodes of each of the node groups 20, all of which is node group information generated by the node-group-information generating unit 12.

In FIG. 2 and FIG. 8, the polling-cycle-storing unit 18 stores a polling cycle of each of the node groups 20. The transmission-packet generating unit 14 generates the group polling packet 4 for the node groups 20 according to the cycle stored in the polling-cycle storing unit 18.

Note that, in FIG. 2 and FIG. 7, when transmission rights are granted to the node groups 20A and 20B including only the nodes 2 that can directly communicate with the AP 1, the transmission-packet generating unit 14 generates the group polling packet 4, a destination of which is broadcast. When transmission rights are granted to the node groups 20C and 20D including the nodes 2 that cannot directly communicate with the AP 1, the transmission-packet generating unit 14 generates the group polling packet 4 having the nodes 2X and 2Y, which are the group polling packet broadcast nodes of the node groups 20C and 20D, as destinations.

In FIG. 2 and FIG. 8, the radio transmission unit 15 transmits the group polling packet 4 generated by the transmission-packet generating unit 14 to the nodes 2.

In FIG. 2, a data-collection-history storing unit 19 retains data collection histories received from the nodes 2 for the number of data collections in the past. The data collection histories include information related to success or failure in reception of data transmitted from the nodes 2.

In FIG. 2, when a packet received from the node 2 is a data transmission packet, the received-packet processing unit 17 of the AP 1 updates the information of the data-collection-history storing unit 19.

In FIG. 3 and FIG. 8, when receiving the group polling packet 4 having the received-packet processing unit 27 as a destination, the received-packet processing unit 27 notifies the transmission-packet generating unit 23 of a group polling packet broadcast request. Thereafter, the received-packet processing unit 27 stores, in the communication-parameter storing unit 24, the CSMA/CA communication parameters in the group polling packet 4, the polling cycle, and the control bitmap 421 related to itself. Thereafter, the received-packet processing unit 27 notifies the transmission-packet generating unit 23 of a data transmission request.

In FIG. 3 and FIG. 8, when a destination is broadcast and the group polling packet 4 for the node group 20 to which the received-packet processing unit 27 belongs is received, the received-packet processing unit 27 stores, in the communication-parameter storing unit 24, the CSMA/CA communication parameters in the group polling packet 4, the polling cycle, and the control bitmap 421 related to itself. Then, the received-packet processing unit 27 notifies the transmission-packet generating unit 23 of a data transmission request.

In FIG. 3 and FIG. 8, when notification from the received-packet processing unit 27 is a group polling packet broadcast request, the transmission-packet generating unit 23 generates a packet in which a destination of the received group polling packet 4 is rewritten to broadcast. When the notification from the received-packet processing unit 27 is a data transmission request, the transmission-packet generating unit 23 acquires transmission data from the transmission-data storing unit 21 and generates a data transmission packet.

In FIG. 3 and FIG. 8, the radio transmission unit 25 transmits the packet, in which the destination of the group polling packet 4 has been rewritten to broadcast, or the data transmission packet. When transmitting the packet, the radio transmission unit 25 performs access control by the CSMA/CA using the communication parameters of the communication-parameter storing unit 24.

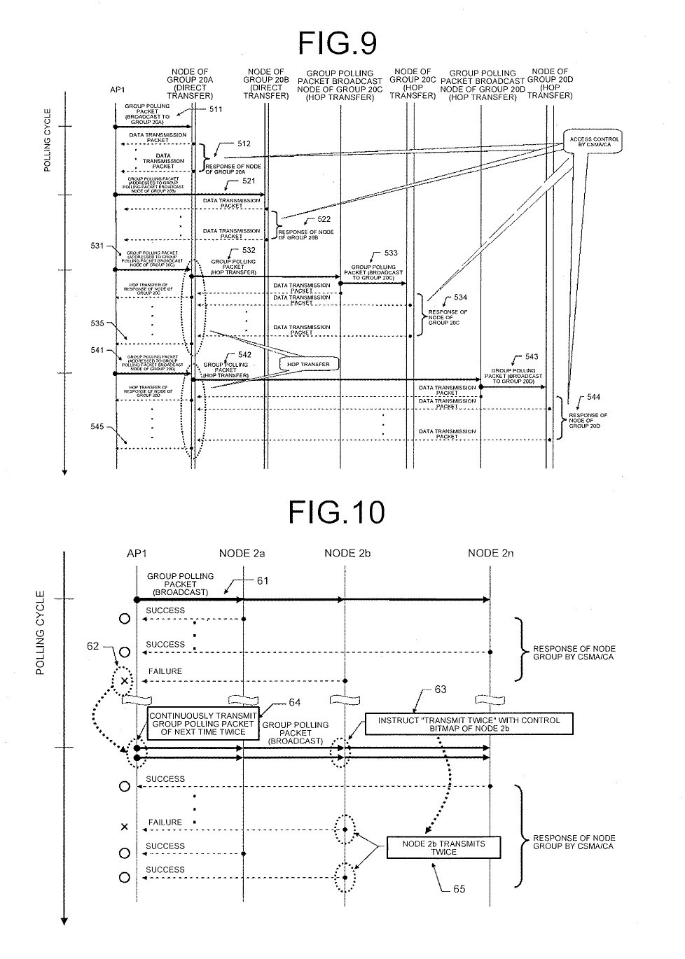

The operation of the radio communication system according to the first embodiment is explained with reference to FIG. 7, FIG. 8, and FIG. 9. FIG. 9 is a diagram showing a normal communication sequence of information collection from the nodes 2 by the group polling packet 4.

In FIG. 9, first, the AP 1 grants a transmission right to the node group 20A. In FIG. 7 and FIG. 8, the AP 1 generates optimum CSMA/CA communication parameters corresponding to the number of nodes of the node group 20A. The AP 1 generates the control bitmap 421 for each of the nodes 2 belonging to the node group 20A. The AP 1 generates the group polling packet 4 for the node group 20A. The group polling packet 4 includes the CSMA/CA communication parameter field 44 including the CSMA/CA communication parameters and the transmission method control bitmap field 42 including the control bitmap 421 for each of the nodes 2. The AP 1 is the group polling packet broadcast node of the node group 20A. Therefore, as shown in FIG. 9, the AP 1 broadcasts the group polling packet 4 for the node group 20A (511).

In FIG. 7 and FIG. 9, from the destination of the received packet and the group ID, the nodes 2 belonging to the node group 20A determine that the group polling packet 4 for the node group 20A to which the nodes 2 belong has been received. The nodes 2 perform access control by the CSMA/CA using information of the CSMA/CA communication parameters field 44 in the received group polling packet 4. The nodes 2 determine possibility of transmission on the basis of the access control by the CSMA/CA. Each of the nodes 2 transmits a data transmission packet to the AP 1 according to a transmission method described in the control bitmap 421 related to the node 2 itself in the transmission method control bitmap field 42 in the received group polling packet 4 (512).

In FIG. 7 and FIG. 9, subsequently, the AP 1 generates the group polling packet 4 for the node group 20B. The group polling packet 4 includes optimum CSMA/CA communication parameters corresponding to the number of nodes of the node group 20B and the control bitmap 421 for each of the nodes 2 belonging to the node group 20B. The AP 1 is the group polling packet broadcast node of the node group 20B. Therefore, as shown in FIG. 9, the AP 1 broadcasts the group polling packet 4 for the node group 20B (521).

From the destination of the received packet and the group ID, the node 2 belonging to the node group 20B determine that the group polling packet 4 for the node group 20B to which the nodes 2 belong has been received. Each of the nodes 2 performs access control by the CSMA/CA using the CSMA/CA communication parameters of the received group polling packet 4. The each node 2 transmits data transmission packets to the AP 1 according to a transmission method described in the control bitmap 421 related to the node 2 itself in the received group polling packet 4 (522).

In FIG. 9, the AP 1 generates the group polling packet 4 for the node group 20C. In FIG. 7 and FIG. 8, the group polling packet 4 includes optimum CSMA/CA communication parameters corresponding to the number of nodes of the node group 20C and the control bitmap 421 for each of the nodes 2 belonging to the node group 20C. The node group 20C is the node group 20 including the node 2 with which the AP 1 can directly communicate and the nodes 2 with which the AP 1 cannot directly communicate. Therefore, as shown in FIG. 9, the AP 1 transmits the group polling packet 4 for the node group 20C with the group polling packet broadcast node of the node group 20C set as a destination (531).

The group polling packet broadcast node of the node group 20C is the node 2 that cannot directly communicate with the AP 1. Therefore, the group polling packet 4 transmitted by the AP 1 is multi-hop transferred to the group polling packet broadcast node of the node group 20C according to a routing path constructed by the network topology generation phase 31 (532). When receiving the group polling packet 4 having the group polling packet broadcast node of the node group 20C as a destination, the group polling packet broadcast node of the node group 20C rewrites the destination of the received group polling packet 4 to broadcast. The group polling packet broadcast node of the node group 20C broadcasts the group polling packet 4, the destination of which is written to broadcast, to the other nodes 2 belonging to the node group 20C (533).

The nodes 2 belonging to the node group 20C including the group polling packet broadcast node perform access control by the CSMA/CA using the CSMA/CA communication parameters of the received group polling packet 4. Each of the nodes 2 transmits a data transmission packet having the AP 1 as a destination according to the transmission method described in the control bitmap 421 related to the node 2 itself in the received group polling packet 4 (534). The data transmission packet is multi-hop transferred to the AP 1 according to the routing path constructed in the network topology generation phase 31 (535).

In FIG. 9, the AP 1 generates the group polling packet 4 for the node group 20D. In FIG. 7 and FIG. 8, the group polling packet 4 includes optimum CSMA/CA communication parameters corresponding to the number of nodes of the node group 20D and the control bitmap 421 for each of the nodes 2 belonging to the node group 20D. The node group 20D is the node group 20D including only the nodes 2 that cannot directly communicate with the AP 1. Therefore, as shown in FIG. 9, the AP 1 transmits the group polling packet 4 for the node group 20D with the group polling packet broadcast node of the node group 20D set as a destination (541).

The group polling packet broadcast node of the node group 20D is the node 2 that cannot directly communicate with the AP 1. Therefore, the group polling packet 4 transmitted by the AP 1 is multi-hop transferred to the group polling packet broadcast node of the node group 20D according to the routing path constructed in the network topology generation phase 31 (542). When receiving the group polling packet 4 having the group polling packet broadcast node of the node group 20D itself as a destination, the group polling packet broadcast node of the node group 20D rewrites the destination of the received group polling packet 4 to broadcast. The group polling packet broadcast node of the node group 20D broadcasts the group polling packet 4, the destination of which has been rewritten to broadcast, to the other nodes 2 belonging to the node group 20D (543).

The nodes 2 belonging to the node group 20D including the group polling packet broadcast node perform access control by the CSMA/CA using the CSMA/CA communication parameters of the received group polling packet 4. Each of the nodes 2 transmits a data transmission packet having the AP 1 as a destination according to the transmission method described in the control bitmap 421 related to the node 2 itself in the received group polling packet 4 (544). The data transmission packet is multi-hop transferred to the AP 1 according to the routing path constructed in the network topology generation phase 31 (545).

Note that different frequency bands are used as frequency bands of radio used in the communication (512, 522, 534, and 544) performed in the node groups 20 using the CSMA/CA communication parameters and the multi-hop transfer (532, 535, 542, and 545). Consequently, it is possible to avoid interference of the CSMA/CA communication and the multi-hop transfer in the node groups 20.

Thereafter, the AP 1 transmits the group polling packet 4 to the node groups 20 in the communication sequence according to the polling cycle stored in the polling-cycle storing unit 18 and cyclically acquires data from the node groups 20.

In this way, the AP 1 cyclically transmits the group polling packet 4 for granting a transmission right to each of the node groups 20. When a group ID coincides with the group ID sent from the AP 1 in advance, the node 2 receiving the group polling packet 4 determines that a transmission right is granted to the node group 20 to which the node 2 itself belongs. Each of the nodes 2 transmits a data transmission packet to the AP 1 while avoiding, with the CSMA/CA, interference with the other nodes 2 in the node group 20 to which the node 2 itself belongs. Consequently, it is possible to suppress an increase in a processing time involved in the use of the polling packet and oppression of a radio band in use and efficiently perform information collection from all the nodes 2 on the large-scale radio communication system.

When performing communication between the AP 1 and the node group 20 including the nodes 2 that cannot directly communicate with the AP 1, the AP 1 transmits the group polling packet 4 having the group polling packet broadcast node as a destination. The group polling packet broadcast node receiving the group polling packet 4 having the group polling packet broadcast node itself as a destination rewrites the destination of the received group polling packet 4 to broadcast. The group polling packet broadcast node broadcasts the group polling packet 4, the destination of which has been rewritten to broadcast, to the other nodes 2 in the node group 20 to which the group polling packet broadcast node itself belongs. The nodes 2 in the node group 20 transmit data transmission packets to the AP 1. The group polling packet 4 and the data transmission packets are multi-hop transferred to the node 2 at the destination or the AP 1 by the nodes 2 according to the routing path constructed in the network topology generation phase 31. Therefore, even when the nodes 2 that cannot directly communicate with the AP 1 are present, it is possible to perform information collection from all the nodes 2 on the radio communication system.

The user can register a different polling cycle for each of the node groups 20 in the polling-cycle storing unit 18 of the AP 1. Consequently, it is possible to collect data at a different cycle for each of the node groups 20.

Further, the polling cycle field 43 includes information concerning a cycle at which the AP 1 transmits the group polling packet 4 to the relevant node group 20. The nodes 2 acquire, using the notified information concerning the cycle, time until transmission of the next group polling packet 4. After transmission of a data transmission packet by the CSMA/CA, the nodes 2 are in a standby state until the time when the next group polling packet 4 is transmitted. Consequently, it is possible to suppress power consumption of the nodes 2.

Note that, in the explanation in the first embodiment, when the AP 1 performs communication with the node group 20 including the nodes 2 that cannot directly communicate with the AP 1, transmission and reception of a packet is performed by the multi-hop transfer. However, the transmission and reception of a packet is not limited to this. That is, in FIG. 7, the node 2A belonging to the node group 20C can directly communicate with the AP 1. Therefore, the node 2A directly transmits a data transmission packet to the AP 1. The node 2B that cannot directly communicate with the AP 1 transmits a data transmission packet having the AP 1 as a destination. The data transmission packet transmitted by the node 2B is multi-hop transferred to the AP 1 according to the routing path constructed in the network topology generation phase 31. With such a configuration, it is possible to efficiently perform information collection from the node group 20C.

### Second Embodiment

A radio communication system according to a second embodiment is explained. As explained in the first embodiment, it is assumed that a large number of nodes 2 are set in a wide range in a factory or a plant to form a large-scale radio communication system. In this case, in communication between the AP 1 and the nodes 2, the AP 1 collects information from the nodes 2 using narrowband radio such as specified low power radio.

Note that, in the second embodiment, as in the first embodiment, the AP 1 collects power consumption of apparatuses detected by the nodes 2. In this case, the radio communication system controls load facilities such that demand does not exceed a contract power value.

To cyclically collect information from the large number of nodes 2, a large number of packets have to be transmitted and received between the AP 1 and the nodes 2. However, because a usable band is small in the narrowband radio, when the radio communication system fails in the communication between the AP 1 and the nodes 2, the AP 1 sometimes does not implement retransmission processing to the nodes 2. In this case, the radio communication system adopts, for example, a method of complementing, using information from the nodes 2 collected in the next cycle, information that the radio communication system has failed in communicating.

However, in general, in the radio communication system that does not perform the retransmission processing, compared with the radio communication system that performs the retransmission processing, a probability of continuous failure in radio communication from the same node 2 is high. When the radio communication system continuously fails in the communication between the AP 1 and the same node 2 several times, demand control is affected. Therefore, in the radio communication system that does not perform the retransmission processing, it is necessary to reduce the probability of continuous failure in radio communication between the AP 1 and the same node 2. Therefore, in the second embodiment, the AP 1 performs transmission method control for the nodes 2 using the group polling packet 4.

The operation of the radio communication system according to the second embodiment is explained with reference to FIG. 2, FIG. 3, FIG. 7, FIG. 8, and FIG. 10. Concerning means same as or equivalent to the means in the first embodiment, explanation is omitted. The present invention is not limited by the second embodiment.

FIG. 10 is a diagram showing a communication sequence in the case of failure in the communication between the AP 1 and the nodes 2. Note that, in the second embodiment, as shown in FIG. 8, the control bitmap 421 is configured by two bits. The AP 1 designates four kinds of transmission methods. The four kinds of transmission methods are, as shown in FIG. 8, (1) “00: stop transmission”, (2) “01: transmit once (normal)”, (3) “10: transmit twice”, and (4) “11: transmit three times”.

In the following explanation in the second embodiment, as shown in FIG. 7, the AP 1 communicates with the nodes 2 belonging to the node group 20A. As shown in FIG. 7 and FIG. 10, the node group 20A is configured by a plurality of nodes 2a to 2n that can directly communicate with the AP 1. As explained in the first embodiment, the AP 1 is the group polling packet broadcast node of the node group 20A. Therefore, as shown in FIG. 10, in information collection from the node group 20A, the AP 1 broadcasts the group polling packet 4 to the node 2a to the node 2n (61).

In FIG. 3, FIG. 7, and FIG. 10, from a destination and a group ID of the received group polling packet 4, the node 2a to the node 2n belonging to the node group 20A determine that the group polling packet 4 is the group polling packet 4 for the node group 20A to which the node 2a to the node 2n belong. The node 2a to the node 2n store, in the communication-parameter storing unit 24, CSMA/CA communication parameters, a polling cycle, and information of the control bitmap 421 related to the node 2a to the node 2n in the received group polling packet 4. Note that the information of the control bitmap 421 related to the node 2a to the node 2n is “01: transmit once (normal)” shown in FIG. 8. The node 2a to the node 2n perform access control by CSMA/CA using the information stored in the communication-parameter storing unit 24 shown in FIG. 3. In FIG. 10, the node 2a to the node 2n transmit data transmission packets to the AP 1.

In FIG. 2, after the transmission of the group polling packet 4, the AP 1 retains, in the data-collection-history storing unit 19, success or failure in reception of data transmitted from the node 2a to the node 2n. As shown in FIG. 10, the AP 1 has failed in reception of the data transmission packet from the node 2b (62). Therefore, the AP 1 changes the information of the control bitmap 421 of the node 2b in the group polling packet 4 (63). Note that the information of the control bitmap 421 of the node 2b after the change is “10: transmit twice” shown in FIG. 8. During the transmission of the group polling packet 4 in the next cycle of a polling cycle, the AP 1 transmits the changed group polling packet 4 to the node 2a to the node 2n twice in the same polling cycle (in the following explanation, referred to as “continuous two times of transmission”) (64).

Each of the nodes 2a to 2n in the node group 20A performs access control by the CSMA/CA using the CSMA/CA communication parameters and the information of the control bitmap 421 related to itself in the received group polling packet 4 and transmit data transmission packets to the AP 1.

On the other hand, to the node 2b, (transmission using) the changed information of the control bitmap 421 is instructed. Note that the changed information of the control bitmap 421 is “10: transmit twice” as shown in FIG. 8. Therefore, the node 2b performs the access control by the CSMA/CA twice and transmits the same data transmission packet twice (65). The AP 1 applies transmission method control to the node 2a to the node 2n in a range in which polling cycles of the node groups 20B, 20C, and 20D excluding the node group 20A are not affected (in the following explanation, referred to as “within a range of an excess band”). Note that the transmission method control means a change of the control bitmap 421 and continuous two times of transmission of the group polling packet 4.

When the data transmission packet can be received twice from the node 2b, the AP 1 changes a transmission method of the node 2b using the group polling packet 4 at the next polling cycle. Note that the transmission method after the change means the normal transmission “01: transmit once (normal)”. The AP 1 stops the continuous two times of transmission of the group polling packet 4 to the node 2a to the node 2n. That is, when the AP 1 can normally receive a transmission packet from the node 2b failed in communication at the preceding cycle of the polling cycle, the AP 1 returns the communication sequence to a normal sequence.

In this way, in the radio communication system that grants transmission rights to the node groups 20 using the group polling packet 4, the AP 1 gives, for example, an instruction for a change of transmission methods to the nodes 2 using the group polling packet 4. When there is a node 2 failed in data reception at the preceding cycle, the AP 1 performs the transmission method control using the excess band. Therefore, even in the radio communication system that does not perform the retransmission processing, it is possible to reduce a probability of continuous failure in information collection from the same node 2. It is also possible to reduce a probability of continuous failure in data collection from the specific node 2 without affecting polling cycles of the other node groups 20.

In the transmission method control, the AP 1 continuously transmits the group polling packet 4 twice to the node group 20 to which the node 2 that failed in data collection last time belongs. Consequently, when the node 2 could not receive the group polling packet 4 transmitted by the AP 1 in the polling cycle of the preceding cycle, it is possible to prevent failure in information collection from the node 2.

The AP 1 changes the control bitmap 421 of the node 2 that failed in data collection last time to “10: transmit twice” as shown in FIG. 8. According to this change, the node 2 performs the access control by the CSMA/CA twice and transmits the same data transmission packet twice. Consequently, when the AP 1 could not receive a data transmission packet transmitted by the node 2 at the last cycle, it is possible to prevent failure in information collection from the node 2.

### Third Embodiment

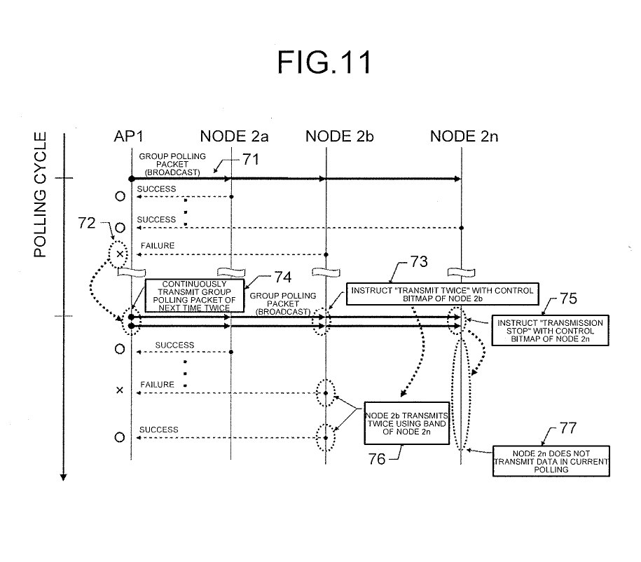

A radio communication system according to a third embodiment is explained with reference to FIG. 2, FIG. 3, FIG. 7, FIG. 8, and FIG. 11. Concerning means same as or equivalent to the means in the first embodiment or the second embodiment, explanation is omitted. The present invention is not limited by the third embodiment.

FIG. 11 is a diagram showing a communication sequence in the case of failure in communication between the AP 1 and the nodes 2 and absence of a band for causing the node 2 that failed in the communication to perform transmission a plurality of times. In this case, if the radio communication system causes the node 2 that failed in communication to perform transmission a plurality of times, the radio communication system cannot keep polling cycles of the other node groups 20.

Note that, in the third embodiment, as shown in FIG. 8, the control bitmap 421 is configured by two bits. The AP 1 designates four kinds of transmission methods. The four kinds of transmission methods are, as shown in FIG. 8, (1) “00: stop transmission”, (2) “01: transmit once (normal)”, (3) “10: transmit twice”, and (4) “11: transmit three times”.

In the following explanation in the third embodiment, as shown in FIG. 7, the AP 1 communicates with the nodes 2 belonging to the node group 20A. As shown in FIG. 7 and FIG. 11, the node group 20A is configured by a plurality of nodes 2a to 2n that can directly communicate with the AP 1. As explained in the first embodiment, the AP 1 is the group polling packet broadcast node of the node group 20A. Therefore, as shown in FIG. 11, in information collection from the node group 20A, the AP 1 broadcasts the group polling packet 4 to the node 2a to the node 2n (71).

In FIG. 3, FIG. 7, and FIG. 11, from a destination and a group ID of the received group polling packet 4, each of the nodes 2a to 2n belonging to the node group 20A determines that the group polling packet 4 is the group polling packet 4 for the node group 20A to which itself belongs. Each of the nodes 2a to 2n stores, in the communication-parameter storing unit 24, CSMA/CA communication parameters, a polling cycle, and information of the control bitmap 421 related to itself in the received group polling packet 4. Note that the information of the control bitmap 421 related to the node 2a to the node 2n is “01: transmit once (normal)” shown in FIG. 8. Each of the nodes 2a to 2n performs access control by CSMA/CA using the information stored in the communication-parameter storing unit 24. In FIG. 11, each of the nodes 2a to 2n transmits a data transmission packet to the AP 1.

In FIG. 2, after the transmission of the group polling packet 4, the AP 1 retains, in the data-collection-history storing unit 19, success or failure in reception of data transmitted from the node 2a to the node 2n. As shown in FIG. 11, the AP 1 has failed in reception of the data transmission packet from the node 2b (72). Therefore, the AP 1 changes the information of the control bitmap 421 of the node 2b in the group polling packet 4 (73). Note that the information of the control bitmap 421 of the node 2b after the change is “10: transmit twice” shown in FIG. 8. During the transmission of the group polling packet 4 in the next cycle of a polling cycle, the AP 1 continuously transmits the changed group polling packet 4 to the node 2a to the node 2n twice (74).

Further, simultaneously with the change and the like, the AP 1 refers to the data-collection-history storing unit 19 in the AP 1 shown in FIG. 2. The AP 1 determines that the AP 1 has continuously succeeded in communication with the node 2n several times before the preceding cycle of the polling cycle. Therefore, the AP 1 changes the information of the control bitmap 421 of the node 2n in the group polling packet 4 (75). Note that the information of the control bitmap 421 of the node 2b after the change is “00: stop transmission” shown in FIG. 8. Consequently, at the next cycle of the polling cycle, the node 2n suspends the transmission. Therefore, a band used for communication between the AP 1 and the nodes 2n before the preceding cycle of the polling cycle changes to an excess band at the next cycle of the polling cycle. The node 2b can perform communication with the AP 1 using the excess band.

Each of the nodes 2a to 2n in the node group 20A performs access control by the CSMA/CA using the CSMA/CA communication parameters and the information of the control bitmap 421 related to itself in the received group polling packet 4 and transmit data transmission packets to the AP 1.

On the other hand, to the node 2b, (transmission using) the changed information of the control bitmap 421 is instructed. Note that the changed information of the control bitmap 421 is “10: transmit twice” as shown in FIG. 8. Therefore, the node 2b performs the access control by the CSMA/CA twice and transmits the same data transmission packet twice (76). The node 2n does not transmit a data transmission packet (77). The AP 1 applies transmission method control to the node 2a to the node 2n. Note that the transmission method control means a change of the control bitmap 421 of the node 2b to the node 2n and continuous two times of transmission of the group polling packet 4.

When the data transmission packet could be received twice from the node 2b, the AP 1 changes transmission methods of the node 2b and the node 2n using the group polling packet 4 at the next polling cycle. Note that the transmission method after the change means the normal transmission “01: transmit once (normal)” in both of the node 2b and the node 2n. The AP 1 stops the continuous two times of transmission of the group polling packet 4 to the node 2a to the node 2n. That is, when the AP 1 can normally receive a transmission packet from the node 2b failed in communication at the preceding cycle of the polling cycle, the AP 1 returns the communication sequence to a normal sequence.

In this way, in the radio communication system that grants transmission rights to the node groups 20 using the group polling packet 4, the AP 1 gives, for example, an instruction for a change of transmission methods to the nodes 2 using the group polling packet 4. When there is a node 2 that failed in data reception at the preceding cycle, the AP 1 performs the transmission method control. Therefore, in the radio communication system that does not perform the retransmission processing, even when a band for causing the node 2 that failed in data collection last time to perform transmission a plurality of times is in sufficient, it is possible to reduce a probability of continuous failure in information collection from the same node 2.

The AP 1 can instruct transmission or a transmission stop for each of the nodes 2 using the transmission method control bitmap field 42 shown in FIG. 8. With such a configuration, it is also possible to collect information from the nodes 2 in the same node group 20 at different cycles.

Note that, in the second embodiment and the third embodiment, as shown in FIG. 8, the control bitmap 421 is configured by two bits. The AP 1 designates the four kinds of transmission methods. The four kinds of transmission methods are, as shown in FIG. 8, (1) “00: stop transmission”, (2) “01: transmit once (normal)”, (3) “10: transmit twice”, and (4) “11: transmit three times”. However, the designation of the transmission methods in the second embodiment and the third embodiment is not limited to this. For example, the number of bits of the control bitmap 421 can be four or more. The designation of the transmission methods in the second embodiment and the third embodiment can be performed by designation of modulation methods.

In the second embodiment and the third embodiment, the AP 1 continuously transmits the group polling packet 4 twice to the node group 20 including the node 2 that failed in the data collection last time. However, the transmission of the group polling packet 4 is not limited to this. If there is an excess band in a band of narrowband radio in use, the AP 1 can continuously transmit the group polling packet 4 three times or more.

In the explanation in the second embodiment and the third embodiment, as shown in FIG. 7, FIG. 10, and FIG. 11, the AP 1 communicates with the node group 20A configured by the node 2a to the node 2n that can directly communicate with the AP 1. However, the communication of the AP 1 is not limited to this. Further, in FIG. 7, the AP 1 can communicate with the node group 20D configured from only the nodes 2 that cannot directly communicate with the AP 1.

In this case, packets that cannot be directly transmitted and received between the AP 1 and the nodes 2 are multi-hop transferred by the nodes 2 on the basis of the routing path of the network constructed in the network topology generation phase 31. The other matters are as indicated by the above explanation contents.

### REFERENCE SIGNS LIST

1 AP (access point)

11 Inter-node-received-power storing unit

12 Node-group-information generating unit

13 Node-group-information storing unit

14 Transmission-packet generating unit

15 Radio transmission unit

16 Radio reception unit

17 Received-packet processing unit

18 Polling-cycle storing unit

19 Data-collection-history storing unit

2 Nodes

2A Node

2B Node

2X Node

2Y Node

2a Node

2b Node

2n Node

20 Node groups

20A Node group

20B Node group

20C Node group

20D Node group

20A(a) Node group

20B(a) Node group

20C(a) Node group

20D(a) Node group

20A(b) Node group

20B(b) Node group

20C(b) Node group

20A(c) Node group

20B(c) Node group

20C(c) Node group

20D(c) Node group

21 Transmission-data storing unit

22 Neighborhood-node received-power-information storing unit

23 Transmission-packet generating unit

24 Communication-parameter storing unit

25 Radio transmission unit

26 Radio reception unit

27 Received-packet processing unit

28 Group-information storing unit

3 Node group construction phase

31 Mesh network topology generation phase

32 Neighborhood-node received power information collection phase

321 Neighborhood-node received power information request packet

322 Neighborhood-node received power information response packet

33 Group ID notification phase

331 Group ID notification packet

4 Group polling packet

41 Group ID field

42 Transmission method control bitmap field

421 Control bitmap

43 Polling cycle field

44 CSMA/CA communication parameter field

511 Group polling packet for the node group 20A

512 Response of nodes of the node group 20A

521 Group polling packet for the node group 20B

522 Response of nodes of the node group 20B

531 Group polling packet addressed to a group polling packet broadcast node of the node group 20C

532 Group polling packet to be multi-hop transferred

533 Group polling packet to be broadcasted to nodes of the node group 20C

534 Response of the nodes of the node group 20C

535 Multi-hop transfer of the response of the nodes of the node group 20C

541 Group polling packet addressed to a group polling packet broadcast node of the node group 20D

542 Group polling packet to be multi-hop transferred

543 Group polling packet to be broadcasted to nodes of the node group 20D

544 Response of the nodes of the node group 20D

545 Multi-hop transfer of the response of the nodes of the node group 20D

61 Group polling packet to be broadcasted to the node 2a to the node 2n

62 Reception failure of response from the node 2b

63 Instruct the node 2b to “transmit twice”

64 Continuous two times of transmission of a group polling packet

65 Node 2b transmits twice

71 Group polling packet to be broadcasted to the node 2a to the node 2n

72 Reception failure of response from the node 2b

73 Instruct the node 2b to “transmit twice”

74 Continuous two times of transmission of a group polling packet

75 Instruct the node 2n to “stop transmission”

76 Node 2b transmits twice

77 Node 2n stops transmission

1. A radio communication system comprising:
a plurality of nodes to collect data of apparatuses; and
an access point to collect the data contained in the plurality of nodes, wherein
the access point arranges, on the basis of neighborhood-node received power information, which is received power information of a radio wave transmitted by neighborhood nodes in each of the nodes, the plurality of nodes into a plurality of groups each including nodes, each of which can mutually receive radio waves transmitted from one another, a number of the nodes being equal to or smaller than a number with which interference avoidance of radio by an access method for avoiding congestion efficiently functions, notifies the plurality of nodes of information related to a group to which each of the nodes belongs, and transmits a polling packet for granting a transmission right to each of the groups, and
when, from the received polling packet, determining that a transmission right is granted to a group to which each of the plurality of nodes belongs, each of the nodes transmits the data to the access point as a packet while avoiding interference with the other nodes in the same group according to the access method.

2. The radio communication system according to claim 1, wherein each of the plurality of nodes receives the same polling packet transmitted by the access point and, when, from the received polling packet, determining that the transmission right is granted to a group to which each of the plurality of nodes belongs, transmits the data to the access point as a packet while avoiding interference with the other nodes in the same group according to the access method.

3. The radio communication system according to claim 1, wherein
the access point selects, concerning a group including a node that cannot directly communicate with the access point among the plurality of groups, a transmission target node to which the polling packet is transmitted out of the nodes in the group and transmits the polling packet with the transmission target node set as a destination,
the transmission target node broadcasts the polling packet to the other nodes in a group to which the transmission target node belongs, and each of the nodes in the group transmits the data as a packet having the access point as a destination while avoiding interference with the other nodes in the same group according to the access method, and
when the access point or each of the plurality of nodes transmits a packet having, as a destination, a partner that cannot directly communicate with the access point or each of the nodes, the plurality of nodes multi-hop transfer the received packet according to a predetermined route.

4. The radio communication system according to claim 3, wherein
the access point cyclically transmits the polling packet to the plurality of groups and, when there is a node that failed in information collection at a last cycle, instructs, using the polling packet, to change a transmission method of the node failed in the information collection, and continuously transmits the polling packet to a group to which the node failed in the information collection belongs, and
the node that failed in the information collection transmits a packet according to the transmission method instructed by the received polling packet.

5. The radio communication system according to claim 3, wherein
the access point generates, for each of the groups, a communication parameter of the access method corresponding to a number of nodes belonging to each of the groups and indicates, using the polling packet, the communication parameter to the nodes belonging to each of the groups to change, and
each of the nodes performs transmission of a packet by the access method using the communication parameter indicated by the received polling packet.

6. The radio communication system according to claim 4, wherein the access point instructs, using an excess band, to change the transmission method of the node failed in the information collection, and when the band is insufficient, instructs, using the polling packet, a node that continuously succeeded in the information collection to stop transmission.

7. The radio communication system according to claim 3, wherein the nodes use respectively different channels in transmission of packets by the access method and the multi-hop transfer.

8. The radio communication system according to claim 3, wherein
the access point notifies, using the polling packet, each of the nodes belonging to the group of a time until transmission of the next polling packet, and
each of the nodes is set to a standby state until the notified time of transmission of the next polling packet after the transmission of the packet by the access method.

9. The radio communication system according to claim 3, wherein the access point instructs, using the polling packet, to transmit or to stop transmission for each of the nodes.

10. A radio communication method comprising:
an access point, which collects, from a plurality of nodes that collect data of apparatuses, the data contained in the plurality of nodes, collecting neighborhood-node received power information, which is received power information of a radio wave transmitted by neighborhood nodes in each of the nodes;
the access point arranging, on the basis of the neighborhood-node received power information, the plurality of nodes into a plurality of groups each including nodes, each of which can mutually receive radio waves transmitted from one another, a number of the nodes being equal to or smaller than a number with which interference avoidance of radio by an access method for avoiding congestion efficiently functions;
the access point notifying the plurality of nodes of information related to a group to which each of the nodes belongs;
the access point transmitting a polling packet for granting a transmission right to each of the groups;
each of the plurality of nodes determining, from the received polling packet, that a transmission right is granted to a group to which each of the nodes belongs; and
each of the plurality of nodes transmitting the data to the access point as a packet while avoiding interference with the other nodes in the same group according to the access method.

11. The radio communication method according to claim 10, further comprising the plurality of nodes respectively receiving the same polling packet transmitted by the access point.

12. The radio communication method according to claim 10, further comprising:
the access point selecting, concerning a group including a node that cannot directly communicate with the access point among the plurality of groups, a transmission target node to which the polling packet is transmitted out of the nodes in the group;
the access point transmitting the polling packet with the transmission target node set as a destination;
the transmission target node broadcasting the polling packet to the other nodes in a group to which the transmission target node belongs;
each of the nodes in the group transmitting the data as a packet having the access point as a destination while avoiding interference with the other nodes in the same group according to the access method; and
when the access point or each of the plurality of nodes transmits a packet having, as a destination, a partner that cannot directly communicate with the access point or each of the nodes, the plurality of nodes multi-hop transferring the received packet according to a predetermined route.

13. The radio communication method according to claim 12, further comprising:
the access point cyclically transmitting the polling packet to the plurality of groups;
when there is a node that failed in information collection at a last cycle, the access point instructing, using the polling packet, to change a transmission method of the node failed in the information collection, and continuously transmitting the polling packet to a group to which the node failed in the information collection belongs; and
the node that failed in the information collection transmitting a packet according to the transmission method instructed by the received polling packet.

14. The radio communication method according to claim 12, further comprising:
the access point generating, for each of the groups, a communication parameter of the access method corresponding to a number of nodes belonging to each of the groups;
the access point indicating, using the polling packet, the communication parameter to the nodes belonging to each of the groups; and
each of the nodes performing transmission of a packet by the access method using the communication parameter indicated by the received polling packet.

15. The radio communication method according to claim 13, further comprising:
the access point instructing, using an excess band, to change the transmission method of the node failed in the information collection; and
when the band is insufficient, the access point instructing, using the polling packet, a node that continuously succeeded in the information collection to stop transmission.

16. The radio communication method according to claim 12, wherein the nodes use respectively different channels in transmission of packets by the access method and the multi-hop transfer.

17. The radio communication method according to claim 12, further comprising:
the access point notifying, using the polling packet, each of the nodes belonging to the group of a time until transmission of the next polling packet; and
each of the nodes being set to a standby state until the notified time of transmission of the next polling packet after the transmission of the packet by the access method.

18. The radio communication method according to claim 12, further comprising the access point instructing, using the polling packet, to transmit or to stop transmission for each of the nodes.

19. A radio communication system comprising:
a plurality of sensors that collect information concerning apparatuses; and
an information collecting apparatus that collects the information concerning the apparatuses through communication with the sensors, determines, before the collection of the information, whether transmission and reception of signals can be performed among the sensors, limits, concerning a plurality of sensor groups generated on the basis of the determination and configured by the plurality of sensors, a number of sensors configuring each of the sensor groups to avoid interference of communication with each of the sensors configuring a sensor group, and constructs the sensor group, wherein
the information collecting apparatus notifies the plurality of sensors of the sensor group of information indicating the sensor group in which each of the sensors is included, and transmits, to the plurality of sensors, information concerning a transmission right indicating a sensor group that communicates with the information collecting apparatus itself, and
when the received information concerning the transmission right is a transmission right of a sensor group to which each of the plurality of sensors belongs, each of the sensors transmits the information concerning the apparatuses to the information collecting apparatus.

20. A radio communication method comprising:
determining whether transmission and reception of signals can be performed among a plurality of sensors that collect information concerning apparatuses;
limiting, concerning a plurality of sensor groups that are generated on the basis of the determination in the determining and configured by the plurality of sensors, a number of sensors configuring the sensor group to avoid interference of radio communication with each of the sensors and constructing a sensor group;
notifying the plurality of sensors of the sensor group constructed by the limiting of information indicating the sensor groups in which the respective sensors are included;
notifying information concerning a transmission right indicating a sensor group with which an information collecting apparatus communicates; and
when information of the received transmission right is information concerning a transmission right of a sensor group to which a sensor belongs, the sensor transmitting the information concerning the apparatuses to the information collecting apparatus.
